(19) United States
(12) Patent Application Publication
(10) Pub. No.: US 2015/0200902 A1
(43) Pub. Date: Jul. 16, 2015

(54) METHODS AND SYSTEMS TO PROCESS A SOCIAL NETWORKING MESSAGE

(71) Applicant: Saumil Ashvin Gandhi, Sunnyvale, CA (US)

(72) Inventor: Saumil Ashvin Gandhi, Sunnyvale, CA (US)

(73) Assignee: EBAY INC., SAN JOSE, CA (US)

(21) Appl. No.: 14/152,110

(22) Filed: Jan. 10, 2014

(51) Int. Cl. H04L 12/58

(52) U.S. Cl. CPC H04L 51/32; H04L 51/04

(57) ABSTRACT

Methods and systems to process a social networking message are described. The system receives a selection that identifies first metadata tag information and a selection that identifies first action information, over a network, at a server machine. The system stores the selection that identifies the first metadata tag information in association with the selection that identifies the first action information as tag information in a database. The system receives a social networking message for publication by a first social networking service. The system parses the social networking message based on the first metadata tag information to identify a first metadata tag in the social networking message. The system initiates a first action that is described by the first action information responsive to the identification of the first metadata tag in the social networking message. Finally, the system publishes the social networking message on the first social networking service.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

This disclosure relates to methods and systems supporting computing and data processing systems. More particularly, methods and systems to process a social networking message are described.

### RELATED ART

Users may send short messages by microblogging or using social networking services. Sometimes they are frustrated with interfaces and features that are not efficient.

### BRIEF DESCRIPTION OF THE DRAWINGS

Embodiments are illustrated by way of example and not limitation in the figures of the accompanying drawings, in which:

FIG. 1 illustrates a system, according to an embodiment, to process a social networking message;

FIG. 2A illustrates user information, according to an embodiment;

FIG. 2B illustrates tag information, according to an embodiment;

FIG. 3A illustrates a method, according to an embodiment, to process a social networking message;

FIG. 3B illustrates a method, according to an embodiment, to configure metadata tag information;

FIG. 3C illustrates a method, according to an embodiment, to process a social networking message;

FIG. 3D illustrates a method, according to an embodiment, to parse a social networking message;

FIG. 3E illustrates a method, according to an embodiment, to initiate an action based on a metadata tag;

FIG. 3F illustrates a method, according to an embodiment, to initiate an action based on a metadata tag;

FIG. 3G illustrates a method, according to an embodiment, to initiate an action based on a metadata tag;

FIGS. 4-5 illustrate user interfaces, according to an embodiment;

FIG. 6 illustrates a system, according to an embodiment;

FIG. 7 is a block diagram illustrating marketplace applications and payment applications, according to an embodiment;

FIG. 8 is a block diagram illustrating tables, according to an embodiment; and

FIG. 9 shows a diagrammatic representation of a machine in the example form of a computer system, according to an example embodiment.

### DETAILED DESCRIPTION

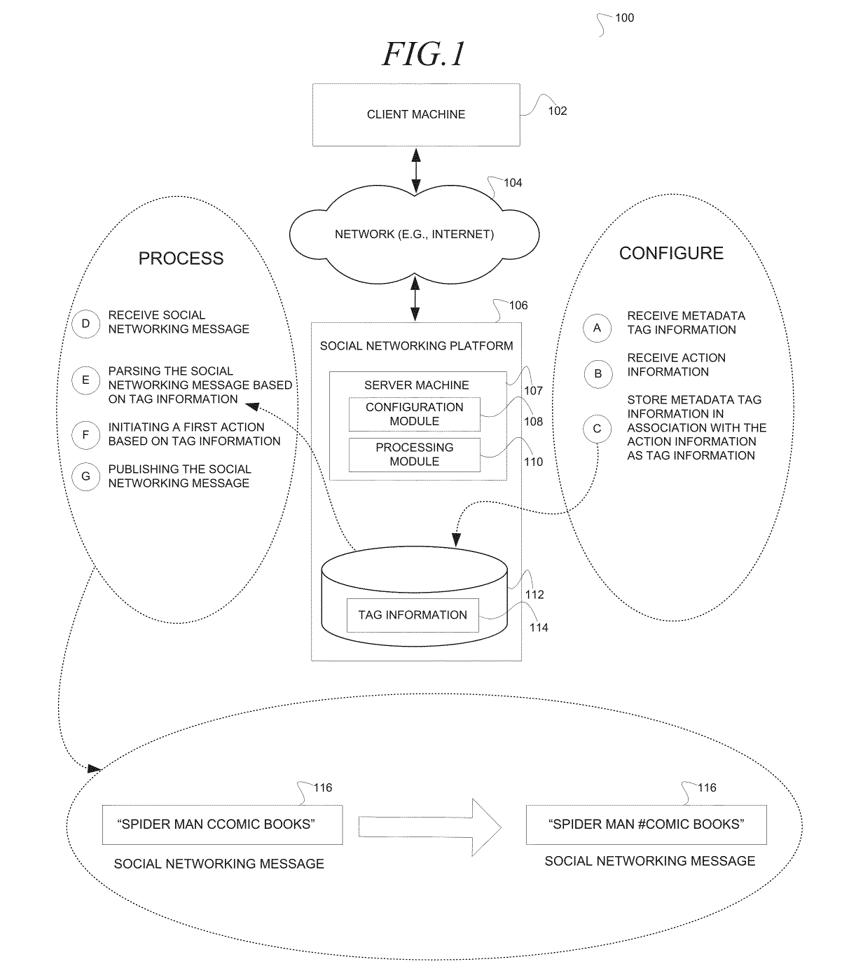

FIG. 1 depicts a system 100, according to an embodiment, to process a social networking message. Broadly, the system 100 includes a client machine 102 that is illustrated on the right as being operated by a user to configure tag information 114 on a social networking platform 106 that hosts a social networking service (e.g., Twitter). Illustrated on the left, the user operates the client machine 102 to communicate a social networking message 116 to the social networking platform 106 where it is processed based on the tag information 114. According to one example embodiment, the social networking platform 106 may parse the social networking message 116 based on the tag information 114 to identify a metadata tag in the social networking message 116, and responsive to the identification of the metadata tag, initiate an action on/from the social networking platform 106. One example action, as illustrated towards the bottom, may include the inserting of the symbol “#” signifying a hashtag in the position of the first “Letter X” (e.g., “C”) in the social networking message 116 responsive to using the tag information 114 (“blank” “Letter X” “Letter X”) to identify the tag (“CC”) in the social networking message 116. The tag information 114 describes a blank followed by the same letter being repeated twice in the social networking message 116. Other tag information 114 may also be configured by the user and utilized to process social networking messages 116 that are published by the user.

According to Wikipedia, “[a] hashtag is a word or an unspaced phrase prefixed with the symbol “#.” It is a form of metadata tag. Short messages on microblogging and social networking services such as Facebook, Twitter or Instagram may be tagged by putting “#” before important words (no spaces), either as they appear in a sentence, (e.g., “New artists announced for #SXSW 2013 Music Festival!”) or appended to it. Hashtags make it possible to group such messages, since one can search for the hashtag and get the set of messages that contain it. A hashtag is only connected to a specific medium and can therefore not be linked and connected to pictures or messages from different platforms.” Accordingly, a user typing the social networking message 116 may efficiently insert a hashtag by repeating the first letter of a word the user intends to hashtag rather than searching the keyboard for the “#” symbol.

The system 100 may be embodied, for example, as a client machine 102 that communicates over a network(s) 104 with a social networking platform 106 that includes a server machine 107 that includes a configuration module 108 and a processing module 110. As described above, the client machine 102 may communicate the tag information 114 over the network 104 to the social networking platform 106 where it is received by the configuration module 108 and stored in a database 112 as tag information 114. Further, the client machine 102 may communicate a social networking message 116 over the network 104 to the social networking platform 106 where the processing module 110 receives, parses, and publishes the social networking message 116 on the social networking platform 106 (e.g., Twitter). Further, as described above, the processing module 110 may initiate one or more actions responsive to parsing the social networking message 116 based on the tag information 114. For example, one action may include the processing module 110 generating the social networking message 116 based on the tag information 114 by inserting a symbol for hashtagging (e.g., “#”). Also for example, another action may include publishing the social networking message 116 on another networking system (e.g., Facebook) responsive to identification of a metadata tag in the social networking message 116. Also for example, another action may include the processing module 110 identifying a query in the social networking message 116 based on the tag information 114 and launching a window on the client machine 102 to execute the query on another platform (e.g., eBay).

### Configuring Tag Information

At operations “A” and “B” the configuration module 108 may receive tag information 114 from the client machine 102. For example, the configuration module 108 may receive a selection that identifies metadata tag information in association with a selection that identifies action information. The metadata tag information may be used to identify a metadata tag in the social networking message 116. For example, the metadata tag information may identify a pattern such as a blank that precedes two of the same letters, a blank that precedes three of the same letters, or some other recognizable pattern that may be identified in a social networking message 116. The action information may be used to define an action that is initiated in response to the identification of a metadata tag in the social networking message 116 based on metadata tag information. At operation “C” the configuration module 108 may store the metadata tag information in association with the action information as tag information 114 in the database 112.

### Processing the Social Networking Message

At operation “D” the processing module 110 may receive a social networking message 116 from the client machine 102 for publication on the social networking platform 106. At operation “E” the processing module 110 may parse the social networking message 116 based on the previously configured tag information 114. At operation “F,” the processing module 110 may initiate one or more actions responsive to the identification of metadata tag(s) in the social networking message 116. At operation “G,” the processing module 110 may publish the social networking message 116 on the social networking platform 106.

The client machine 102 may be embodied as a personal data assistant, an electronic tablet, or a notebook computer (not shown). The client machine 102 may further be embodied as a desktop (not shown), deskside computer system (not shown), or terminal (not shown), for example. The network 104 may include any combination of hardware, software, or technology that enables communication between the client machine 102 and the social networking platform 106. For example, the network 104 may be embodied as the Verizon 4G network, the Internet, a private wide area network (WAN), or any combination thereof. The social networking platform 106 may be embodied as Twitter, an online social networking and microblogging service of San Francisco, Calif., that enables users to send and read “tweets,” which are text messages limited to 140 characters; Tout, an online social networking service and microblogging service that enables its users to send and view 15-second videos, known as “touts,” also of San Francisco, Calif.; Tumblr, a microblogging platform and social networking website that allows users to post multimedia and other content to a short-form blog; Instagram, an online photo-sharing, video-sharing and social networking service of Menlo Park Calif., that enables its users to take pictures and videos, apply digital filters to them, and share them on a variety of social networking services; Flickr, an image hosting and video hosting website, and web services suite; and Facebook, a social utility of Menlo Park, Calif., that connects you with the people around you.

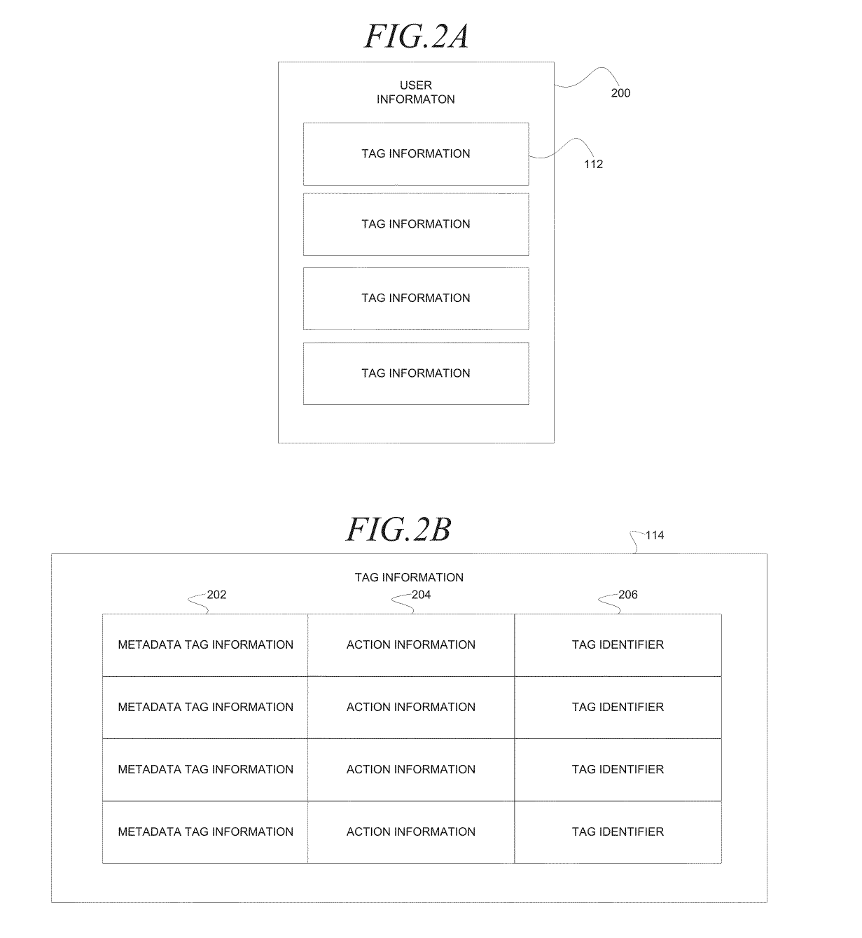

FIG. 2A is a block diagram illustrating user information 200, according to an embodiment. The user information 200 may include a tag information 114 entry for each user on the social networking platform 106. Accordingly, each user may configure their tag information 114 separately.

FIG. 2B illustrates tag information 114, according to an embodiment. The tag information 114 may include metadata tag information 202, action information 204, and tag identifiers 206. Particular metadata tag information 202 may be associated with particular action information 204 as identified and accessed by the corresponding tag identifier 206. The metadata tag information 202 may be used to identify an instance of a metadata tag in a social networking message 116. One example of metadata tag information 202 may include “blank,” followed by a “letter X,” followed by a “letter X,” and a particular matching instance in a social networking message 116 (as shown in FIG. 1) may include “CC” where the expression “letter X” represents any single letter regardless of capitalization and the expression “blank” is a space, as previously described. The action information 204 may describe an action that is performed responsive to identifying the metadata tag being identified in a social networking message 116 based on the metadata tag information 202. For example, an action may include inserting a hashtag symbol in place of the first letter in the repeating letters, “letter X,” “letter X” (e.g., “CC”->“#C”).

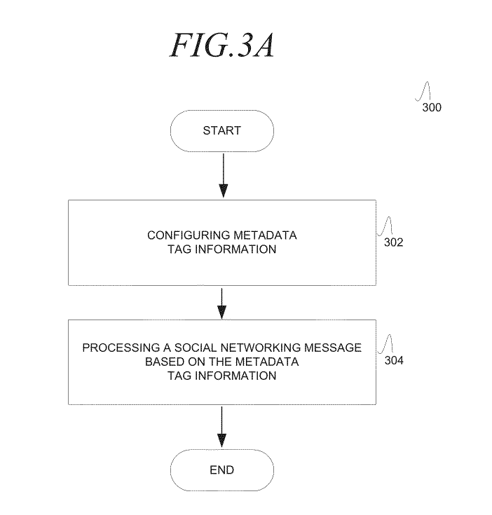

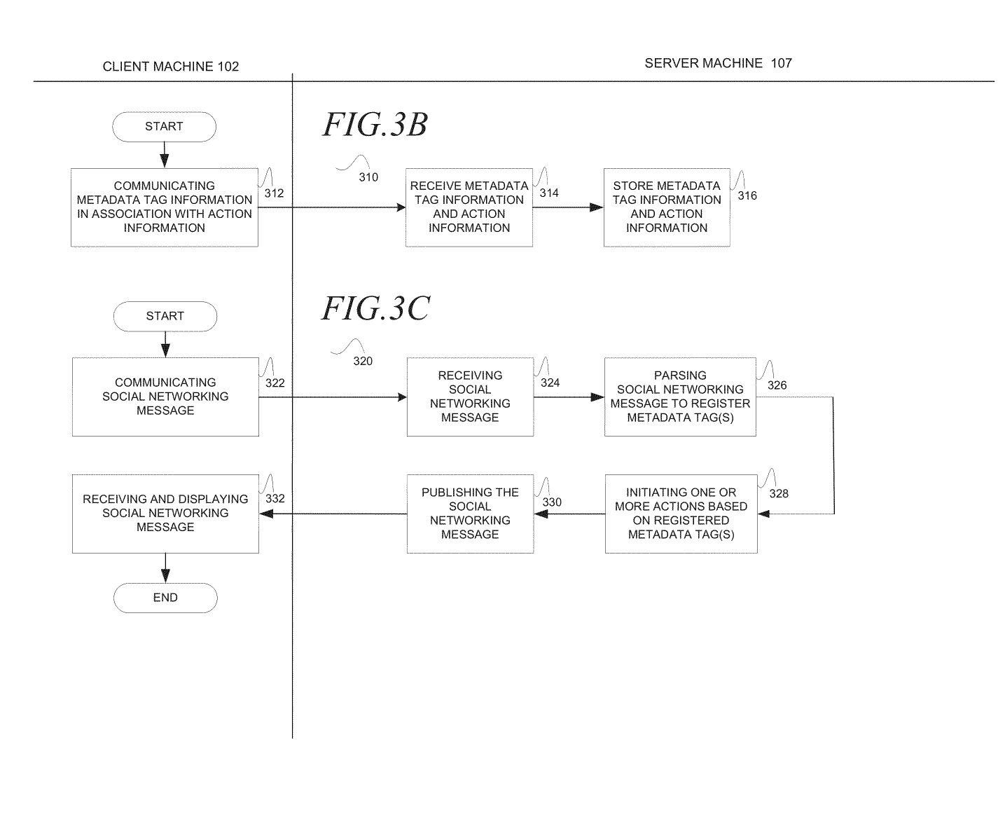

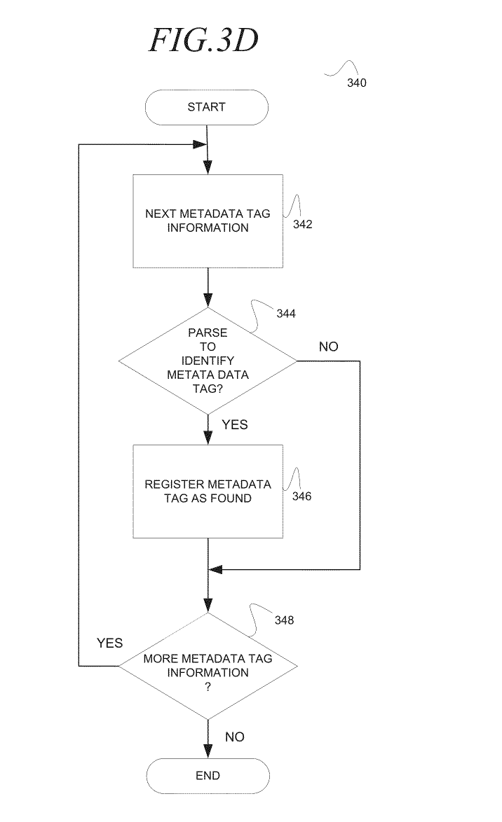

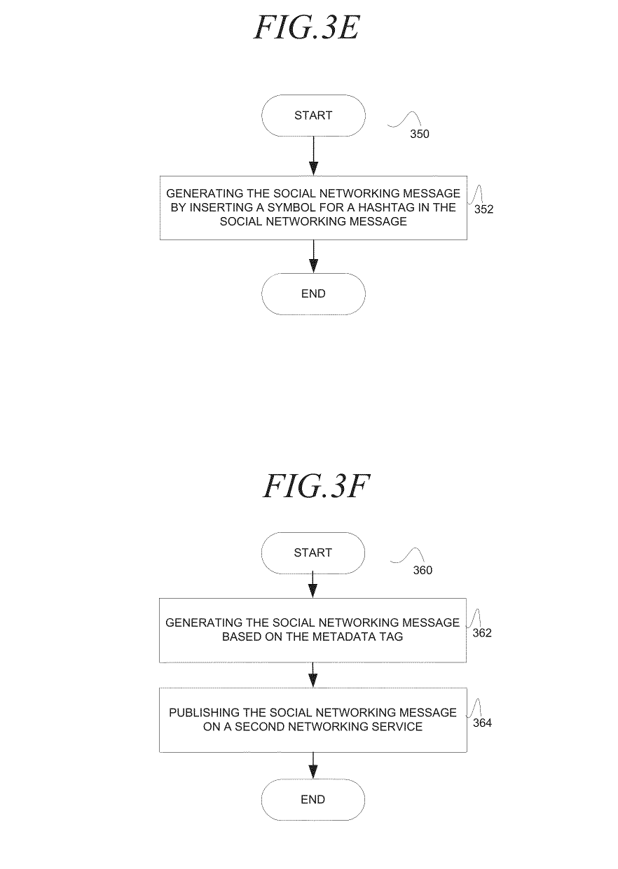

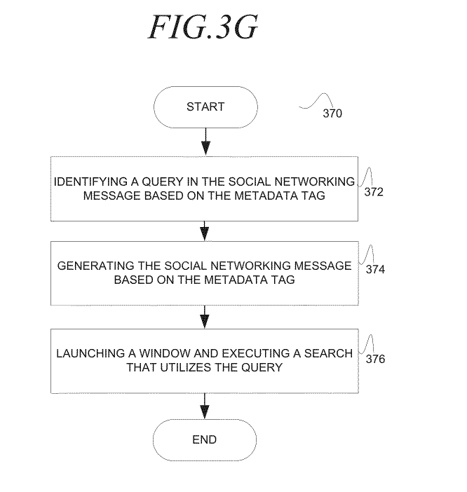

FIG. 3A illustrates a method 300, according to an embodiment, to process a social networking message 116. The method 300 may commence at operation 302 with a social networking platform 106 receiving a request to configure tag information 114. The request may include a selection that identifies first metadata tag information 202 and a selection that identifies first action information 204, as described above. Further, at operation 302, the social networking platform 106 may store the two selections in association with each other as tag information 114 in association with a particular user in a database 112 that is coupled to a social networking platform 106 (shown in FIG. 1). The method 300 is described in further detail in FIG. 3B.

At operation 304, the social networking platform 106 may process a social networking message 116 based on the tag information 114. For example, the social networking platform 106 may receive a social networking message 116 over a network 104 from a client machine 102, parse the social networking message 116 based on the first metadata tag information to identify a first metadata tag, initiate a first action responsive to identifying the first metadata tag, and publish the social networking message 116. The operation 304 is described in further detail in FIG. 3C.

FIG. 3B illustrates a method 310, according to an embodiment, to configure tag information 114. The method 310 corresponds to the method 302 on FIG. 3A and provides further detail. Illustrated on the left is a client machine 102 and illustrated on the right is a server machine 107 at a social networking platform 106. The method 310 may commence at operation 312, with the client machine 102 communicating a request to configure tag information 114 to the server machine 107. The request may include a selection that identifies first metadata tag information and a selection that identifies first action information.

At operation 314, at the social networking platform 106, the configuration module 108 may receive the request and at operation 316, the configuration module 108 may store the selection that identifies first metadata tag information and a selection that identifies first action information in association with each other as tag information 114 in the user information 200 based on the user that made the request.

FIG. 3C illustrates a method 320, according to an embodiment, to process a social networking message 116. The method 320 corresponds to the operation 304 on FIG. 3A. Illustrated on the left is a client machine 102 and illustrated on the right is a server machine 107 at a social networking platform 106. The method 320 may commence at operation 322, with the client machine 102 communicating a request to publish a social networking message 116 to the server machine 107. In one embodiment, the request may include both the social networking message 116 and the request to publish the social networking message 116.

At operation 324, at the server machine 107, the processing module 110 may receive the request and at operation 326 the processing module 110 may parse the social networking message 116 based on the metadata tag information 202 in the tag information 114 to register one or more metadata tags as described further in FIG. 3D. At operation 328, the processing module 110 may initiate one or more actions based on the metadata tags that were registered. For example, the processing module 110 may insert a standard symbol for a hashtag (as shown in FIG. 3E), publish the social networking message 116 on another social networking platform (as shown in FIG. 3F), or launch a window and execute a search (as shown in FIG. 3G). At operation 330, the processing module 110 may publish the social networking message 116 on the social networking platform 106 (e.g., Twitter).

At operation 332, the client machine 102 may receive and display the social networking message 116. In one example, the client machine 102 may display the social networking message 116 with the standard symbol for a hashtag. In another example, the client machine 102 may launch a second window and execute a search (e.g., eBay). In another example, the client machine 102 may publish the same social networking message 116 but from a different social networking service (e.g., Facebook). Further, any of the above actions may be performed in combination.

FIG. 3D illustrates a method 340, according to an embodiment, to parse a social networking message 116. The method 340 corresponds to the method 320 on FIG. 3C and provides further detail. The method 340 may be performed by the processing module 110 at the social networking platform 106 in response to receiving a social networking message 116 at the social networking platform 106. At operation 342, the processing module 110 may retrieve the next metadata tag information 202 from the tag information 114 associated with the user that communicated the social networking message 116 to the social networking platform 106 (as shown in operation 322 on FIG. 3C). At decision operation 344, the processing module 110 may parse the social networking message 116 to identify a metadata tag in the social networking message 116 based on the metadata tag information 202. For example, the processing module 110 may parse the social networking message 116, “SPIDER MAN CCOMIC BOOKS,” to identify a metadata tag, “CC” in the social networking message 116 based on the metadata tag information 202, “blank,” “letter X,” “letter X.” If the processing module 110 parses the social networking message 116 to identify a metadata tag, then processing continues at operation 346. Otherwise processing continues at decision operation 348. At operation 346, the processing module 110 may register a metadata tag as found. For example, the processing module 110 may register the metadata tag by storing in memory the metadata tag identifier 206 in association with the metadata tag that was found. At decision operation 348, the processing module 110 may identify whether more metadata tag information 202 is present in the tag information 114. If more metadata tag information 202 is present in the tag information 114, then a branch is made to operation 342. Otherwise the process ends.

FIG. 3E illustrates a method 350, according to an embodiment, to initiate an action based on a metadata tag. The method 350 may be performed by the processing module 110 at the social networking platform 106. The method 350 corresponds to the operation 328 on FIG. 3C. At operation 352, the processing module 110 may generate the social networking message 116 by inserting a symbol for a hashtag in the social networking message 116 based on the metadata tag “CC” that was registered as identified in operation 346 in FIG. 3D. For example, the processing module 110 may insert the symbol “#” in the social networking message “SPIDER MAN CCOMIC BOOKS,” based on the metadata tag, “CC” to generate the social networking message 116 that includes the message “SPIDER MAN #COMIC BOOKS.”

FIG. 3F illustrates a method 360, according to an embodiment, to initiate an action based on a metadata tag. The method 360 may be performed by the processing module 110 at the social networking platform 106. The method 360 corresponds to the operation 328 on FIG. 3C. At operation 362, the processing module 110 may generate the social networking message 116 based on the metadata tag that was registered as identified in operation 346 in FIG. 3D. For example, the processing module 110 may remove the letter “C” in the social networking message “SPIDER MAN CCOMIC BOOKS,” based on the metadata tag, “CC” to generate the social networking message 116 that includes the message “SPIDER MAN COMIC BOOKS” for publication on another networking service. At operation 364, the processing module 110 may publish the social networking message 116 on a second networking service based on a metadata tag. For example, the processing module 110 may publish the social networking message 116 that includes the message “SPIDER MAN COMIC BOOKS” on a second networking service (e.g., Facebook) in addition to publishing the social networking message 116 on the present social networking service (e.g., Twitter), as performed in operation 330 in FIG. 3C.

FIG. 3G illustrates a method 370, according to an embodiment, to initiate an action based on a metadata tag. The method 370 may be performed by the processing module 110 at the social networking platform 106 responsive to the identification of the metadata tag in a social networking message 116. The method 370 corresponds to the operation 328 on FIG. 3C. At operation 372, the processing module 110 may identify a query in the social networking message 116 based on a metadata tag that was registered as identified in operation 346 in FIG. 3D. For example, the processing module 110 may identify the query “SPIDERMAN” in the social networking message “SSPIDERMAN COMIC BOOKS,” based on the metadata tag “SS.” At operation 374, the processing module 110 may generate the social networking message 116 for publishing based on a metadata tag “SS.” For example, the processing module 110 may generate the social networking message 116 that includes the message “SPIDER MAN COMIC BOOKS” for publishing based on the social networking message “SSPIDERMAN COMIC BOOKS” and the metadata tag “SS.” At operation 376, the processing module 110 may communicate a command to the client machine 102 that causes the client machine 102 to launch a second window on the client machine 102 and initiate a search on a predetermined website (e.g., eBay) that utilizes the identified query “SPIDERMAN.”

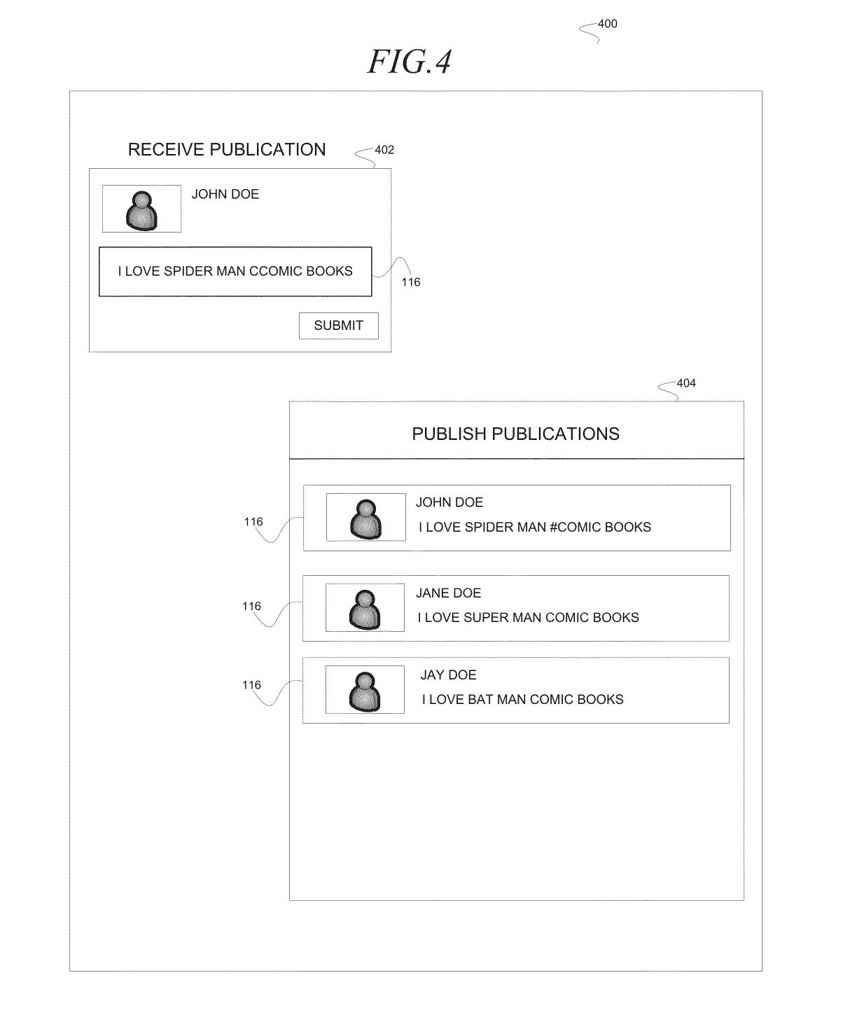

FIG. 4 illustrates a user interface 400, according to an embodiment, to receive and publish a social networking message 116. The user interface 400 may include a receiving panel 402 and a publishing panel 404. The receiving panel 402 may be used to receive a social networking message 116. For example, the social networking message 116 that includes the message “I LOVE SPIDER MAN CCOMIC BOOKS” may be authored by “John Doe” and received via the receiving panel 402 over a network by processing module 110 at a server machine 107 in a social networking platform 106 (e.g., Twitter). The publishing panel 404 may be used to publish one or more social networking messages 116 for display on a client machine 102 as shown in FIG. 1. The publishing panel 404 illustrates the publication on the social networking platform 106 (e.g., Twitter) of three social networking messages 116 that were authored and published by three users on the social networking platform 106, namely, “John Doe.” “Jane Doe” and “Jay Doe.” The social networking message 116 that is positioned at the top of the publishing panel 404 is the same social networking message 116 that is illustrated in the receiving panel 402, as processed according to the method 350 shown in FIG. 3E to insert the symbol “#” for a hashtagging in place of the letter “C.” Further, multiple metadata tags may be identified in a single social networking message 116. Merely for example, the receiving panel 402 may receive the social networking message 116 “Sspiderman and Ccomics” which is processed according to the method 350 shown in FIG. 3E to insert the symbol “#” for hashtagging in place of the letter “S” and in place of the letter “C” to yield the publication “of the social networking message 116, “#spiderman and #comics” in the publishing panel 404.

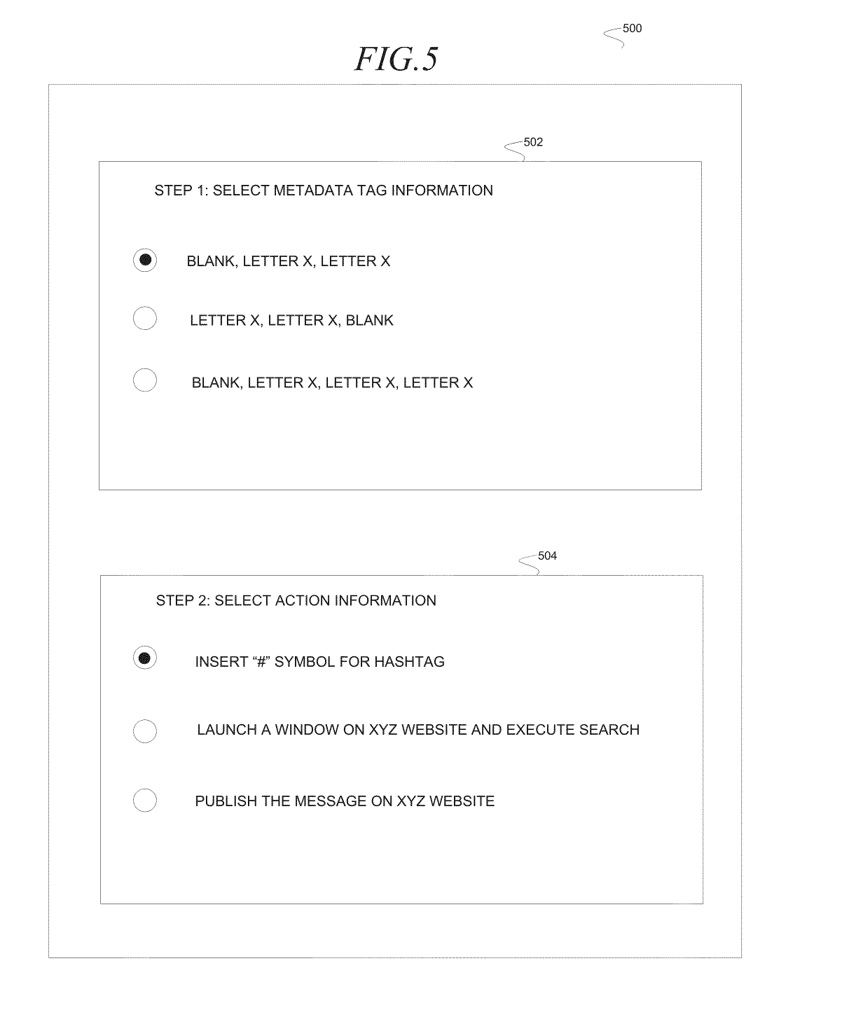

FIG. 5 illustrates a user interface 500, according to an embodiment, to receive metadata tag information 202 and action information 204. The user interface 500 may include metadata tag information panel 502 and action information panel 504. The metadata tag information panel 502 may be used to receive a selection that identifies metadata tag information 202 and the action information panel 504 that may be used to receive a selection that identifies action information 204. Responsive to receipt of a selection that identifies metadata tag information 202 and a selection that identifies action information 204, the configuration module 108 may store the identified metadata tag information 202 and identified action information 204 in association with each other along with the next available tag identifier 206 as tag information 114 in the appropriate entry in the user information 200 on the database 112.

### Network-Based Marketplace

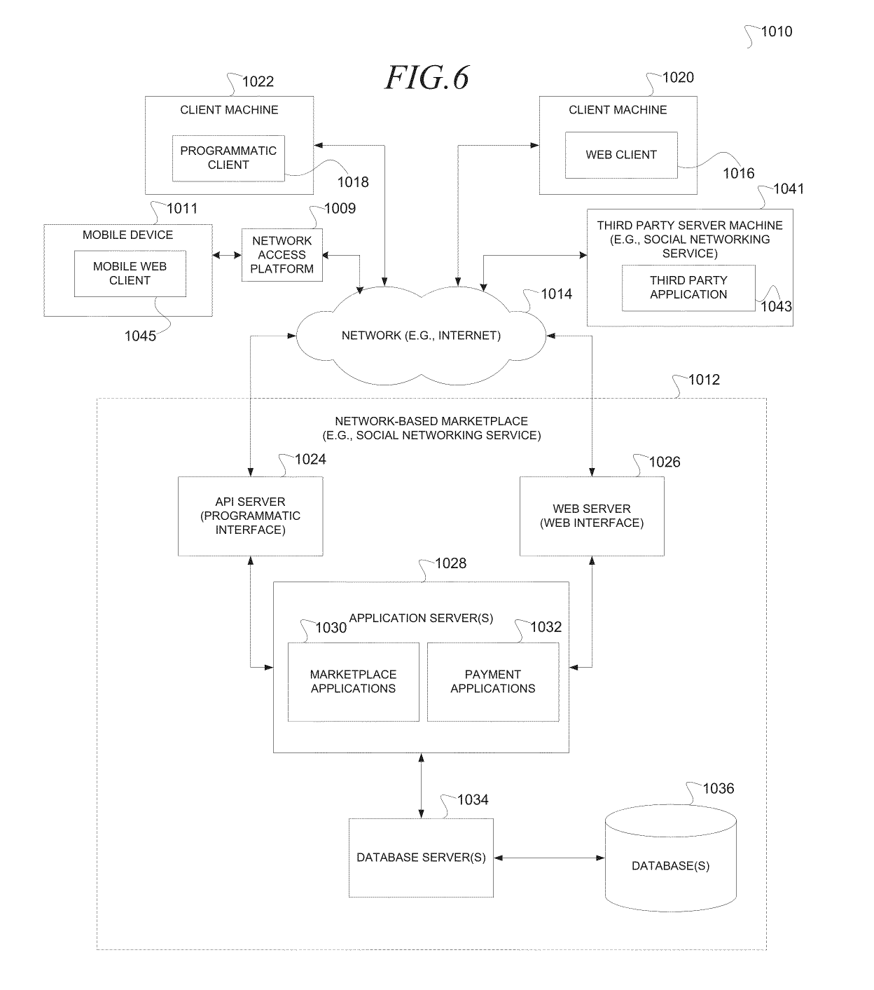

FIG. 6 illustrates a system 1010, according to an embodiment. The networked system 1010 corresponds to the system 100 in FIG. 1; accordingly, the same or similar references have been used to indicate the same or similar features unless otherwise indicated. The networked system 1010 may include a network-based marketplace 1012 (e.g., social networking platform). The network-based marketplace 1012 provides server-side functionality, via a network 1014 (e.g., the Internet or wide area network (WAN)) to one or more clients. FIG. 6 illustrates, for example, a web client 1016 (e.g., a browser, such as the Internet Explorer browser developed by Microsoft Corporation of Redmond, Wash. State) executing on client machine 1020, a programmatic client 1018 executing on client machine 1022, and a mobile web client 1045 executing on mobile device 1011 (e.g., client machine). For example, the mobile web client 1045 may be embodied as one or more mobile modules that are used to support the Blackberry™ wireless hand held business or smart phone manufactured by Research In Motion of Waterloo, Ontario.

An application program interface (API) server 1024 and a web server 1026 are coupled to, and provide programmatic and web interfaces respectively to, one or more application servers 1028. The application servers 1028 host one or more marketplace applications 1030 and payment applications 1032. The application servers 1028 are, in turn, shown to be coupled to one or more database servers 1034 that facilitate access to one or more databases 1036.

The marketplace applications 1030 may provide a number of marketplace functions and services to users that access the network-based marketplace 1012. The payment applications 1032 may likewise provide a number of payment services and functions to users. The payment applications 1032 may allow users to accumulate value in accounts and then to later redeem the accumulated value for products (e.g., goods or services) that are made available via the marketplace applications 1030. The value may be accumulated in a commercial currency, such as the U.S. dollar, or a proprietary currency, such as “points.” While the marketplace applications 1030 and payment applications 1032 are shown in FIG. 6 to both form part of the network-based marketplace 1012, it will be appreciated that, in alternative embodiments, the payment applications 1032 may form part of a payment service that is separate and distinct from the network-based marketplace 1012.

Further, while the networked system 1010 shown in FIG. 6 employs client-server architecture, embodiments of the present disclosure are of course not limited to such an architecture and could equally well find application in a distributed, or peer-to-peer, architecture system, for example. The various marketplace applications 1030 and payment applications 1032 could also be implemented as standalone software programs, which do not necessarily have networking capabilities.

The web client 1016 and mobile web client 1045 access the various marketplace applications 1030 and payment applications 1032 via the web interface supported by the web server 1026. Similarly, the programmatic client 1018 accesses the various services and functions provided by the marketplace applications 1030 and payment applications 1032 via the programmatic interface provided by the API server 1024. The programmatic client 1018 may, for example, be a seller application (e.g., the TurboLister application developed by eBay Inc., of San Jose, Calif.) to enable sellers to author and manage listings on the network-based marketplace 1012 in an off-line manner, and to perform batch-mode communications between the programmatic client 1018 and the network-based marketplace 1012.

FIG. 6 also illustrates a third party application 1043, executing on a third party server machine 1041, as having programmatic access to the networked system 1010 via the programmatic interface provided by the API server 1024. The third party website may communicate user interfaces to the client machines 1022, 1020 or mobile device 1011.

The mobile device 1011 may be embodied as a mobile phone, a personal digital assistant (PDA), a cell phone, or any other wireless device that is capable of communicating with the network-based marketplace 1012. For example, the mobile device 1011 may be embodied as an iPhone mobile phone manufactured by Apple, Inc. of Cupertino, Calif. or, as previously mentioned, a Blackberry™ mobile phone manufactured by Research In Motion of Waterloo, Ontario.

### Marketplace and Payment Applications

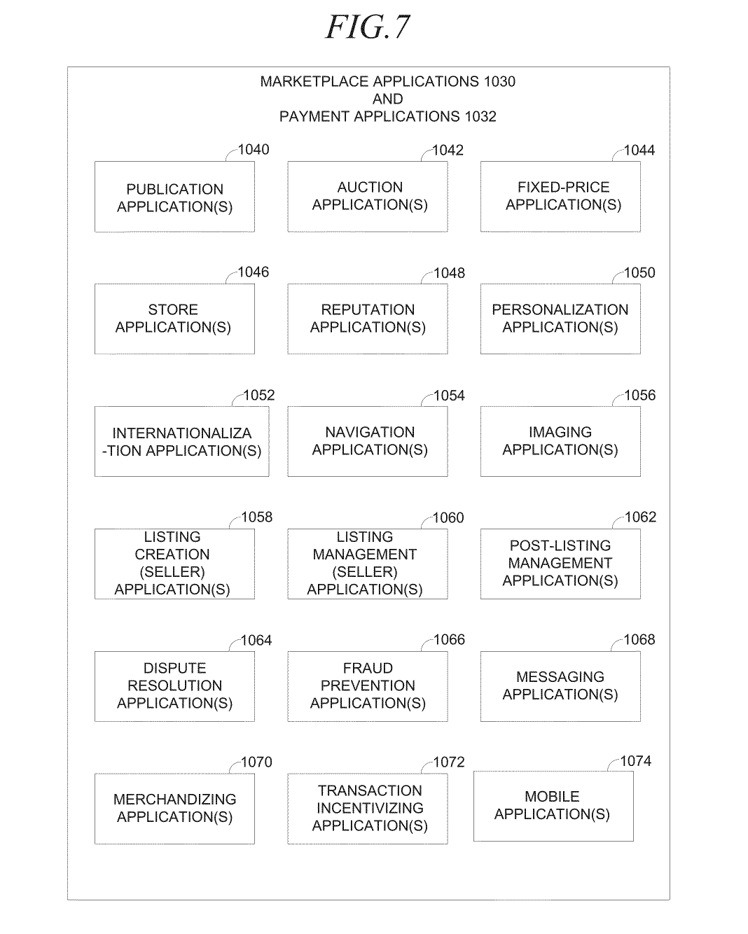

FIG. 7 is a block diagram illustrating marketplace applications 1030 and payment applications 1032 that, in one example embodiment, are provided as part of the networked system 1010 of FIG. 6. The marketplace applications 1030 and payment applications 1032 may be hosted on dedicated or shared server machines, as shown on FIG. 6, that are communicatively coupled to enable communications between server machines. The applications 1030 and 1032 themselves are communicatively coupled (e.g., via appropriate interfaces) to each other and to various data sources, so as to allow information to be passed between the applications 1030 and 1032 or so as to allow the applications 1030 and 1032 to share and access common data. The applications 1030 and 1032 may furthermore access one or more databases 1036 via the database servers 1034, as shown on FIG. 6. The network-based marketplace 1012 of FIG. 6 may provide a number of publishing, listing and price-setting mechanisms whereby a seller may list (or publish information concerning) goods or services for sale; a buyer may indicate a desire to purchase such goods or services; and a price can be set for a transaction pertaining to the goods or services. To this end, the marketplace and payment applications 1030 and 1032 are shown to include publication applications 1040 and auction applications 1042. The publication applications 1040 may, for example, include the previously described configuration module 108 and the processing module 110, according to an embodiment. The one or more auction applications 1042 may support auction-format listing and price setting mechanisms (e.g., English, Dutch, Vickrey, Chinese, Double, Reverse auctions, etc.) in addition to providing a number of features in support of such auction-format listings, such as a reserve price feature whereby a seller may specify a reserve price in connection with a listing and a proxy-bidding feature whereby a bidder may invoke automated proxy bidding.

A number of fixed-price applications 1044 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and may allow a buyer to purchase goods or services, which are also being offered for sale via an auction, for a fixed price that is typically higher than the starting price of the auction.

Store application(s) 1046 allows a seller to group listings within a “virtual” store, which may be branded and otherwise personalized by and for the seller. Such a virtual store may also offer promotions, incentives and features that are specific and personalized to a relevant seller.

Reputation applications 1048 allow users that transact, utilizing the network-based marketplace 1012, to establish, build and maintain reputations, which may be made available and published to potential trading partners. Consider that where, for example, the network-based marketplace 1012 supports person-to-person trading, users may otherwise have no history or other reference information whereby the trustworthiness and credibility of potential trading partners may be assessed. The reputation applications 1048 allow a user to establish a reputation within the network-based marketplace 1012 over time, for example, through feedback provided by other transaction partners and by the computation of a feedback score based on the feedback. For example, the feedback score may be publicly displayed by the network-based marketplace 1012. Other potential trading partners may then reference such a feedback score for the purposes of assessing credibility and trustworthiness.

Personalization applications 1050 allow users of the network-based marketplace 1012 to personalize various properties of their interactions with the network-based marketplace 1012. For example, a user may, utilizing an appropriate personalization application 1050, create a personalized reference page at which information regarding transactions to which the user is (or has been) a party may be viewed. Further, a personalization application 1050 may enable a user to personalize listings and other properties of their interactions with the networked system 1010 and other parties.

The networked system 1010 may support a number of marketplaces that are customized, for example, for specific geographic regions. A version of the networked system 1010 may be customized for the United Kingdom, whereas another version of the networked system 1010 may be customized for the United States. Some of these versions may operate as an independent marketplace, or may be customized (or internationalized) presentations of a common underlying marketplace. The networked system 1010 may accordingly include a number of internationalization applications 1052 that customize information (and/or the presentation of information) by the networked system 1010 according to predetermined criteria (e.g., geographic, demographic or marketplace criteria). For example, the internationalization applications 1052 may be used to support the customization of information for a number of regional websites that are operated by the networked system 1010 and that are accessible via respective servers 1024 and 1026 both of FIG. 6.

Navigation of the network-based marketplace 1012 may be facilitated by one or more navigation applications 1054. For example, the network-based marketplace 1012 may receive search information to search for items on the network-based marketplace 1012. A browse application may allow users to browse various category, catalogue, or inventory data structures according to which listings may be classified within the networked system 1010. Various other navigation applications may be provided to supplement the search and browsing applications.

In order to make listings available via the networked system 1010 as visually informing and attractive as possible, the marketplace and payment applications 1030 and 1032 may include one or more imaging applications 1056 with which users may upload images (e.g., thumbnail images) for inclusion within listings. An imaging application 1056 also operates to incorporate images (e.g., thumbnail images) within viewed listings. The imaging applications 1056 may also support one or more promotional features, such as image galleries that are presented to potential buyers. For example, sellers may pay an additional fee to have an image included within a gallery of images for promoted items.

Listing creation applications 1058 allow sellers to conveniently author listings pertaining to goods or services that they wish to transact via the network-based marketplace 1012, while the listing management applications 1060 allow sellers to manage such listings. Specifically, where a particular seller has authored and/or published a large number of listings, the management of such listings may present a challenge. The listing creation applications 1058 may further facilitate a buyer watching specific listings or specific types of listings. The listing management applications 1060 provide a number of features (e.g., auto-relisting, inventory level monitors, etc.) to assist the seller in managing such listings.

One or more post-listing management applications 1062 may also assist sellers with a number of activities that may typically occur post-listing. For example, upon completion of an auction facilitated by one or more auction applications 1042, a seller may wish to leave feedback regarding a particular buyer. To this end, a post-listing management application 1062 may provide an interface to one or more reputation applications 1048, so as to allow the seller conveniently to provide feedback regarding multiple buyers to the reputation applications 1048.

Dispute resolution applications 1064 provide mechanisms whereby disputes arising between transacting parties may be resolved. For example, the dispute resolution applications 1064 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 1066 implement fraud detection and prevention mechanisms to reduce the occurrence of fraud within the network-based marketplace 1012.

Messaging applications 1068 are responsible for the generation and delivery of messages to users of the network-based marketplace 1012, with such messages, for example, advising users regarding the status of listings at the network-based marketplace 1012 (e.g., providing “outbid” notices to bidders during an auction process or to providing promotional and merchandising information to users). Respective messaging applications 1068 may utilize any one of a number of message delivery networks and platforms to deliver messages to users. For example, messaging applications 1068 may deliver electronic mail (e-mail), instant message (IM), short message service (SMS), text, facsimile, or voice (e.g., voice over IP (VoIP)) messages via the wired (e.g., the Internet), plain old telephone service (POTS), or wireless (e.g., mobile, cellular, WiFi (e.g., IEEE 802.11 technologies including 802.11n, 802.11b, 802.11g, and 802.11a)), worldwide interoperability for microwave access (e.g., WiMAX—IEEE 802.16) networks.

Merchandising applications 1070 support various merchandising functions that are made available to sellers to enable sellers to increase sales via the network-based marketplace 1012. The merchandising applications 1070 also operate the various merchandising features that may be invoked by sellers and may monitor and track the success of merchandising strategies employed by sellers. In addition, the user may utilize the transaction incentivizing applications 1072 to select one or more criterion that may be used to generate a social goodness index that is used to generate a badge. Mobile applications 1074 support mobile devices that access the features and services that are provided by the network-based marketplace 1012.

### Data Structures

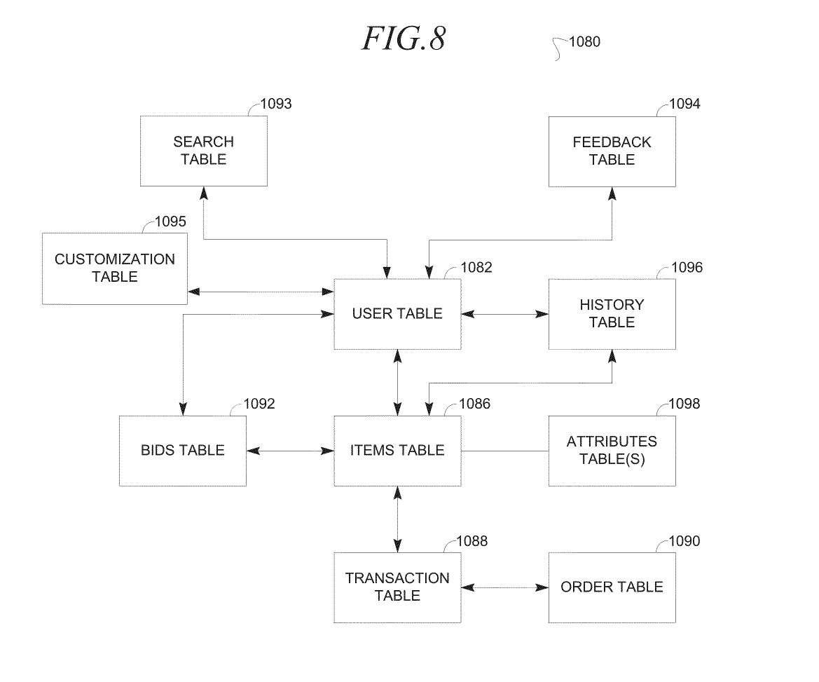

FIG. 8 is a high-level entity-relationship diagram, illustrating various tables 1080 that may be maintained within the databases 1036 of FIG. 6, and that are utilized by and support the marketplace applications 1030 and payment applications 1032 both of FIG. 7. A user table 1082 contains a record for registered users of the network-based marketplace 1012 of FIG. 6. A user may operate as a seller, a buyer, or both, within the network-based marketplace 1012. In one example embodiment, a buyer may be a user that has accumulated value (e.g., commercial or proprietary currency), and is accordingly able to exchange the accumulated value for items that are offered for sale by the network-based marketplace 1012.

The tables 1080 also include an items table 1086 in which item records (e.g., listings) are maintained for goods and services that are available to be, or have been, transacted via the network-based marketplace 1012. Item records (e.g., listings) within the items table 1086 may furthermore be linked to one or more user records within the user table 1082, so as to associate a seller and one or more actual or potential buyers with an item record (e.g., listing). According to one embodiment, the user table 1082 may be used to store user information 200 that includes the previously described tag information 114.

A transaction table 1088 may contain a record for each transaction (e.g., a purchase or sale transaction or auction) pertaining to items for which records exist within the items table 1086.

An order table 1090 may be populated with order records, with each order record being associated with an order. Each order, in turn, may be associated with one or more transactions for which records exist within the transaction table 1088.

Bid records within a bids table 1092 may relate to a bid received at the network-based marketplace 1012 in connection with an auction-format listing supported by an auction application 1042 of FIG. 7. A feedback table 1094 is utilized by one or more reputation applications 1048 of FIG. 7, in one example embodiment, to construct and maintain reputation information concerning users in the form of a feedback score. A history table 1096 may maintain a history of transactions to which a user has been a party. One or more attributes tables 1098 may record attribute information that pertains to items for which records exist within the items table 1086. Considering only a single example of such an attribute, the attributes tables 1098 may indicate a currency attribute associated with a particular item, with the currency attribute identifying the currency of a price for the relevant item as specified by a seller.

A search table 1093 may store search information that has been entered by a user (e.g., buyer) who is looking for a specific type of listing. A customization table 1095 may store customization information.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connects the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 1014 (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture/Machine-Readable Medium

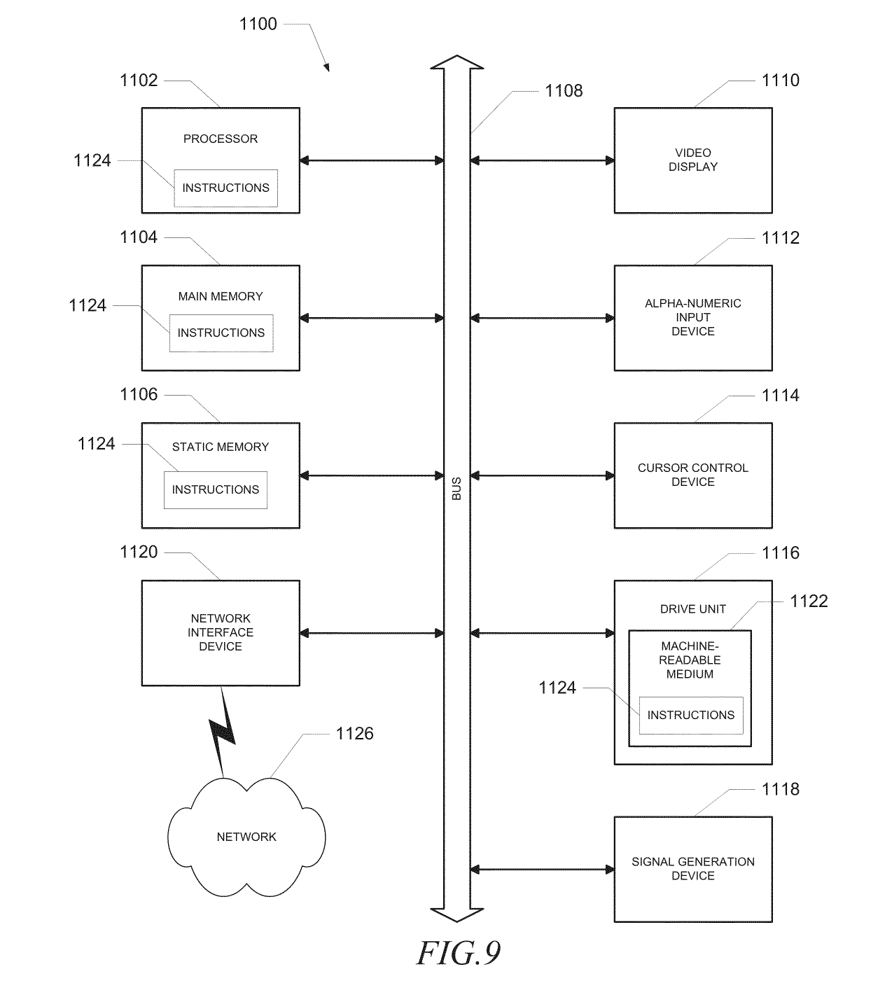

FIG. 9 is a block diagram of a machine within which instructions may be executed for causing the machine to perform any one or more of the methodologies discussed herein. In one example embodiment, the machine may be the client machine 102 or any other client machine mentioned in the present disclosure. In one example embodiment, the machine may be the mobile device 1011 or any other mobile device mentioned in the present disclosure. In one example embodiment, the machine may be the server machine 107 or any other server machine mentioned in the present disclosure. In alternative embodiments, the machine operates as a standalone device or may be connected (e.g., networked) to other machines. In a networked deployment, the machine may operate in the capacity of a server or a client machine 102 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (or cursor control) device 1114 (e.g., a mouse), a disk drive unit 1116, a signal generation device 1118 (e.g., a speaker) and a network interface device 1120.

### Machine-Readable Medium

The drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media 1122. Instructions may also reside within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions 1124 for execution by the machine and that cause the machine to perform any one or more of the methodologies of the present disclosure, or that is capable of storing, encoding or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, methods and systems to process a social networking message were disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A system comprising:
a processor;
a configuration module that is executable by the processor to configure tag information, the configuration module being configured to receive a selection that identifies first metadata tag information and a selection that identifies first action information, over a network, at a server machine, the configuration module being further configured to store the selection that identifies the first metadata tag information in association with the selection that identifies the first action information as tag information in a database; and
a processing module that is executable by the processor to process a social networking message based on the tag information, the processing module being configured to receive a social networking message, over the network at the server machine, for publication by a first social networking service, the processing module being further configured to parse the social networking message based on the first metadata tag information to identify a first metadata tag in the social networking message, the processing module being further configured to initiate a first action that is described by the first action information responsive to the identification of the first metadata tag in the social networking message, the processing module being further configured to publish the social networking message on the first social networking service.

2. The system of claim 1, wherein the processing module is configured to identify a blank followed by two matching letters.

3. The system of claim 1, wherein the processing module is configured to insert a symbol for a hashtag in the social networking message responsive to an identification of the first metadata tag.

4. The system of claim 1, wherein the processing module is configured to publish the social networking message on a second networking service.

5. The system of claim 1, wherein the processing module is configured to launch a window and execute a search.

6. The system of claim 5, wherein the processing module is configured to utilize the first metadata tag to identify a query in the social networking message.

7. The system of claim 1, wherein the processing module is configured to identify two matching letters followed by a blank.

8. The system of claim 7, wherein the processing module is configured to parse the social networking message responsive to submission of the social networking message.

9. The system of claim 1, wherein the processing module is configured to parse the social networking message based on the metadata tag information to identify a second metadata tag in the social networking message and wherein the processing module is configured to initiate a second action responsive to the identification of the second metadata tag.

10. A method comprising:
configuring tag information, the configuring the tag information comprising:
receiving a selection that identifies first metadata tag information and a selection that identifies first action information, over a network, at a server machine;
storing the selection that identifies the first metadata tag information in association with the selection that identifies the first action information as tag information in a database;
processing a social networking message based on the tag information, the processing the social networking message comprising:
receiving the social networking message, over the network at the server machine, for publication by a first social networking service;
parsing the social networking message based on the first metadata tag information to identify a first metadata tag in the social networking message;
initiating a first action that is described by the first action information responsive to the identifying of the first metadata tag in the social networking message; and
publishing the social networking message on the first social networking service.

11. The method of claim 10, wherein the identifying the first metadata tag includes identifying a blank being followed by two matching letters.

12. The method of claim 10, wherein the initiating the first action includes inserting a symbol for a hashtag in the social networking message responsive to identifying the first metadata tag.

13. The method of claim 10, wherein the initiating the first action includes publishing the social networking message on a second networking service.

14. The method of claim 10, wherein the initiating the first action includes launching a window and executing a search.

15. The method of claim 14, wherein the first metadata tag is utilized to identify a query in the social networking message for executing the search.

16. The method of claim 10, wherein the identifying the first metadata tag includes identifying two matching letters being followed by a blank.

17. The method of claim 16, wherein the parsing the social networking message includes parsing the social networking message responsive to identifying that the social networking message is being submitted.

18. The method of claim 10, further comprising:
parsing the social networking message based on the metadata tag information to identify a second metadata tag in the social networking message; and
initiating a second action responsive to the identification of the second metadata tag.

19. A non-transitory machine-readable medium storing instructions that, when executed by a machine, cause the machine to:
receive a selection that identifies first metadata tag information and a selection that identifies first action information, over a network, at a server machine;
store the selection that identifies the first metadata tag information in association with the selection that identifies the first action information as tag information in a database;
receive a social networking message, over the network at the server machine, for publication by a first social networking service;
parse the social networking message based on the first metadata tag information to identify a first metadata tag in the social networking message;
initiate a first action that is described by the first action information responsive to the identifying of the first metadata tag in the social networking message; and
publish the social networking message on the first social networking service.

20. The non-transitory machine-readable medium of claim 19, wherein the first metadata tag includes a blank being followed by two matching letters.
